(19) United States
(12) Patent Application Publication
(10) Pub. No.: US 2026/0002880 A1
(43) Pub. Date: Jan. 1, 2026

(54) EVALUATION OF ABNORMALITIES OF A SAMPLE

(71) Applicant: NOVA LTD., Rehovot (IL)

(72) Inventors: Yonatan OREN, Kiryat Ono (IL); Gilad Barak, Rehovot (IL)

(73) Assignee: NOVA LTD., Rehovot (IL)

(21) Appl. No.: 18/879,240

(22) PCT Filed: Jun. 30, 2023
(86) PCT No.: PCT/IB2023/056807

§ 371 Date: Dec. 26, 2024

Related U.S. Application Data
(60) Provisional application No. 63/357,025, filed on Jun. 30, 2022.

(51) Int. Cl. G01N 21/88; G01N 21/17

(52) U.S. Cl. CPC G01N 21/8806; G01N 21/1717; G01N 2021/1725

(57) ABSTRACT

A method for evaluating a sample, the method includes performing one or more pump probe measurements, wherein a pump probe measurement includes (i) illuminating the sample by a laser pump beam that is modulated by a modulation frequency; (ii) illuminating the sample by a laser probe beam; (iii) detecting radiation resulting from the illumination of the sample; (iv) determining, based on the detected radiation, thermo-reflectance information regarding a sample region located at a depth of the sample; wherein the thermo-reflectance information comprises information about an oscillatory component of a thermal response of the sample measured during the pump probe measurement; and (v) determining a presence of one or more sample abnormalities based on the analysis results.

### CROSS REFERENCE

This application claims priority from U.S. provisional patent Ser. No. 63/357,025 filing date Jun. 30, 2022 which is incorporated herein in its entirety.

### BACKGROUND

To meet the ever-increasing demand for computing power in diverse applications like mobile devices, data centers and automotive, a continuous improvement in the performance and efficiency of integrated circuit devices is needed. These devices can be generally divided to two parts: the front-end-of-line (FEOL) which contains the CMOS transistors and their immediate electrical contacts, and the back-end-of-line (BEOL) which comprises the complex network of wiring that connects these transistors between themselves and to the outside world.

FIG. 1 illustrates an example of a CMOS chip 10 with metal interconnects in the BEOL.

Two main performance metrics of the device intimately depend on the metal interconnects: (I) The switching speed, which dictates the maximum performance, depends on the “RC” product of the circuit—i.e. the electrical resistance of the metal lines multiplied by the capacitance of the lines and the surrounding dielectric medium. This is increasingly becoming limited by the BEOL rather than the transistors in the FEOL, and (II) The power dissipation depends on the electric resistance of the circuit. In modern chips the total length of interconnects can easily exceed hundreds of meters, so controlling their resistance is crucial for improving the energetic efficiency of the device.

The resistance of interconnects can be impacted by many factors in the design and manufacturing process of a chip. One of these is the unintentional formation of voids, or unfilled regions, inside the interconnect during the deposition process. These voids can occur in all types of deposition (usually electroplating for Cu or Chemical Vapor Deposition for other metals) and can form for various reasons such as problems with the process materials or with the deposition tool itself.

FIG. 2 illustrates examples 20 of voids. The examples include: (a) a void in metal-2 interconnect, (b) voids in Tungsten vias, (c) voids in Cu Through-Silicon-Vias, and (d) a void in a flip-chip solder bump.

Unlike many other process excursions, voids are notoriously difficult to detect once the deposition is complete. The reason for this is that the metal surrounding them is optically opaque, making most optical metrology and inspection techniques used to monitor the process inadequate for the detection of voids. Other techniques such as cross-section scanning electron microscope (SEM) and transmissive transmission electron microscope (TEM) are destructive and slow, making them unsuitable for in-line monitoring.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a chip;

FIG. 2 illustrates examples of voids;

FIG. 3 illustrates the real and imaginary Thermo-Optic, and Thermo-Reflectance coefficients—at different wavelengths of Silicon;

FIG. 4A illustrates an example of a spatial temperature profile due to DC and AC components of the pump beam.

FIG. 4B illustrates an example of a calculated propagation of the AC thermal component, showing the wave-like behavior with velocity of a square root of 2ωD;

FIG. 5 illustrates an example of an evaluation system;

FIG. 6 illustrates an example of a simulated item;

FIGS. 7 and 8 illustrate results of a simulation;

FIG. 9 illustrates an example of a method; and

FIG. 10 illustrates an example of an evaluation system.

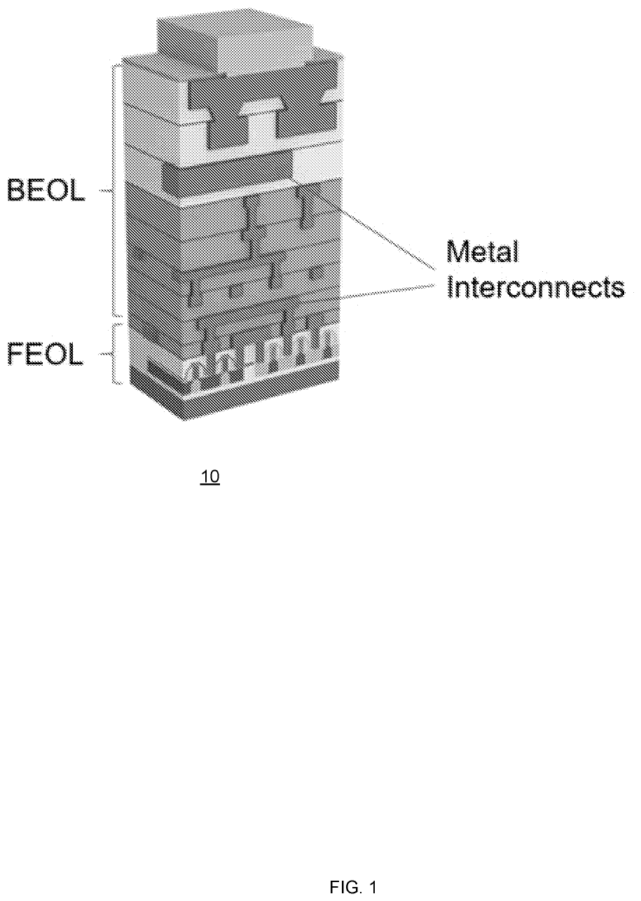

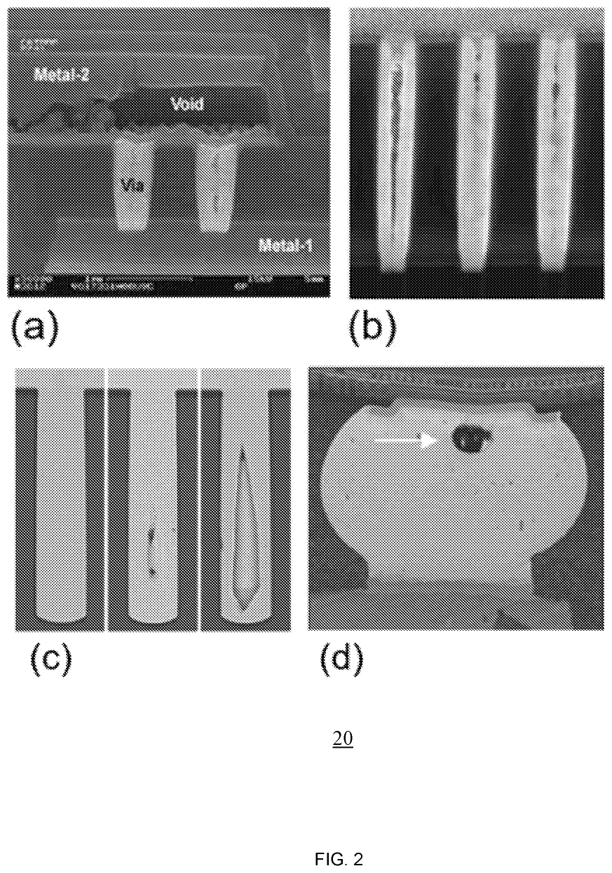

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using optical components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a non-transitory computer readable medium that stores instructions that once executed by a computer result in the execution of the method.

Any reference in the specification to a non-transitory computer readable medium should be applied mutatis mutandis to a method that may be executed by a computer that reads the instructions stored in the non-transitory computer readable medium.

While the disclosure relates to void defects, it should be understood that the proposed approach can be similarly applied to other types of structural abnormalities. Examples include line roughness, abnormal cross-section profile and even some material properties (such as grain size for polycrystalline materials or concentration if relevant). The underlying requirement for the proposed method is that the property of interest has a direct influence on the thermal conductance properties of the metal line.

According to an embodiment, there is provided a non-transitory computer readable medium for evaluating a sample, the non-transitory computer readable medium stores instructions that once executed by a measurement system causes the measurement system to: perform one or more pump probe measurements, wherein a pump probe measurement comprises: illuminating the sample by a laser pump beam that is modulated by a modulation frequency; illuminating the sample by a laser probe beam; detecting radiation resulting from the illumination of the sample; determining, based on the detected radiation, thermo-reflectance information regarding a sample region located at a depth of the sample; thermo-reflectance information comprises information about an oscillatory component of a thermal response of the sample measured during the pump probe measurement; and determining a presence of one or more sample abnormalities based on the analysis results.

In the proposed disclosure we outline an optical technique for detecting the presence of voids and abnormalities. This has the advantages of being non-contact, non-destructive and fast compared to alternative methods allowing for in-line process control. The method is a type of pump-probe technique, where a modulated pump laser is used to induce thermal changes in the sample and a second probe laser is used to measure the thermal response through its secondary effect on the sample's optical properties.

The proposed invention makes use of the interaction of light and heat as a way to probe into opaque structures. Generally, the optical properties of matter are temperature dependent. This is embodied in the thermo-optic coefficients which quantify the change in refractive index vs. temperature to first order around some reference temperature:

$$n ( T ) = n ( {T}_{0} ) + \frac{\partial n}{\partial t} {\vert}_{{T}_{0}} ( T - {T}_{0} )$$

The thermo-optic coefficients are typically on the order of ˜10⁻⁵K⁻¹.

The reflectivity of light at normal incidence to a surface is directly related to the complex refractive index n:

$$R = {\vert \frac{n - 1}{n + 1} \vert}^{2} ,$$

outlining the basic physical mechanism we can use for probing the thermal response of a device, and thus its internal structure, with light.

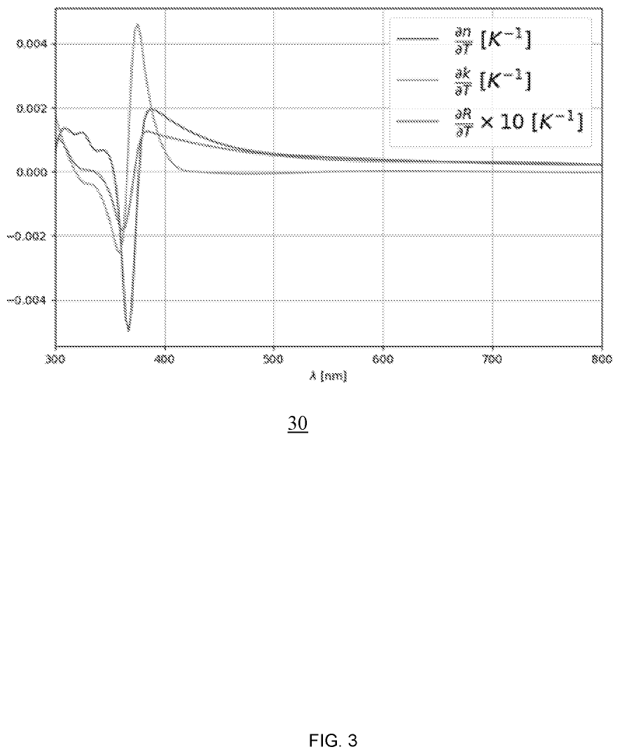

An example of the spectral dependence of the thermo-optic coefficients and the resulting sensitivity of the reflectivity (thermo-reflectance) in Silicon are given in FIG. 3.

FIG. 3 illustrates the real and imaginary Thermo-Optic, and Thermo-Reflectance coefficients—at different wavelengths (collectively denoted 30) of Silicon.

### Modulated Pump-Probe Reflectometry

As mentioned, the proposed method uses an amplitude-modulated pump laser to heat the sample. This has several advantages over a continuous pump.

Small signal measurement. The sample cannot be heated by more than ˜few-tens degrees in order to avoid damaging the material. As the thermo-reflectance ∂R/∂T is typically on the order of ˜10⁻⁴-10⁻⁵K⁻¹, the induced change in reflectivity is rather small and would be difficult to measure due to low frequency (a.k.a “1/f”) noises. The standard remedy for this is to modulate the pump at some frequency f_{mod} and measure the probe using a lock-in amplifier to isolate only the corresponding response at f_{mod}

Heating profile. The pump modulation also has an important functional role. Consider a pump power profile described by P(t)=P₀[1+cos ωt]/2. Since heat diffusion is to good approximation a linear effect, the heat source created by the pump absorption in the sample can be decomposed into a constant (“DC”) and oscillatory (“AC”) components, and the response can be solved for each of them separately.

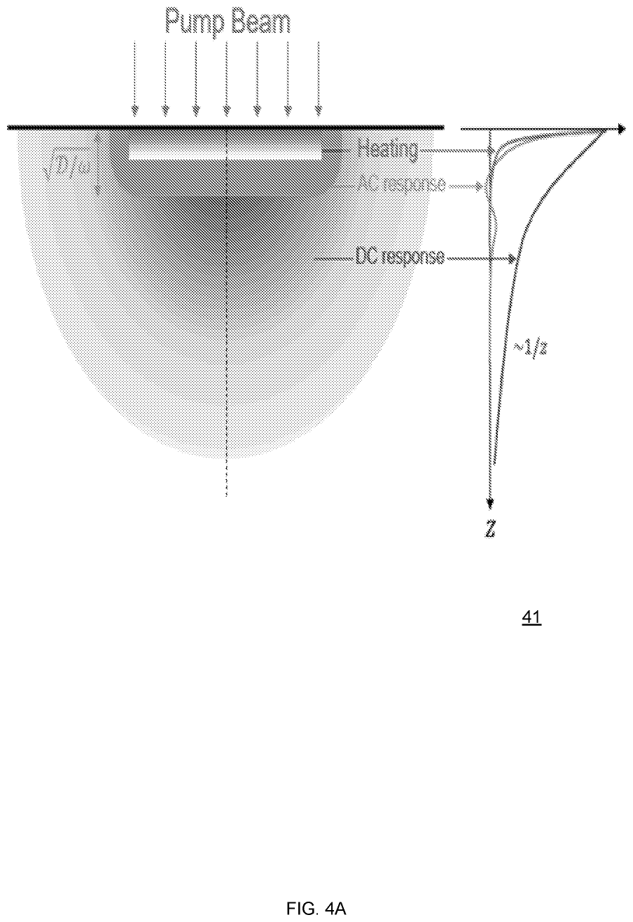

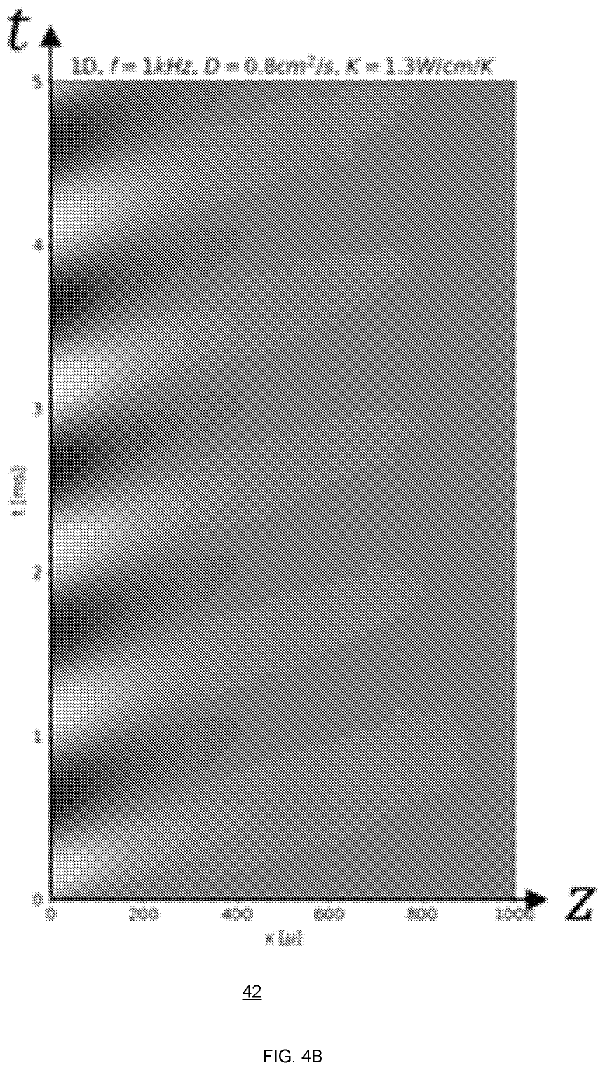

The temperature profile created by these two contributions is schematically shown in FIGS. 4A and 4B. FIG. 4A illustrates the spatial temperature profile 41 due to DC and AC components of the pump beam. FIG. 4B illustrates the calculated propagation 42 of the AC thermal component, showing the wave-like behavior with velocity of a square root of 2ωD.

It should be noticed that the AC part is that it has an intrinsic length scale determined by the modulation frequency and the material's thermal diffusivity: Lₘ=\sqrt{/ω}.

When the spot size is much larger than the pump penetration depth and Lₘ, the solution behaves like a decaying plane wave propagating a distance ˜Lₘ into the sample. An example of a spot diameter size is between 1-2 microns and about 100 microns—especially 102-microns.

Since the lock-in amplifiers discards the DC part, we are only interested in the behavior of the AC part. The ability to change the heat penetration profile by varying the frequency allows, by measuring at multiple frequencies, to greatly increase the amount of information obtained and account for unknown parameters which would otherwise hamper the ability to correctly interpret the results.

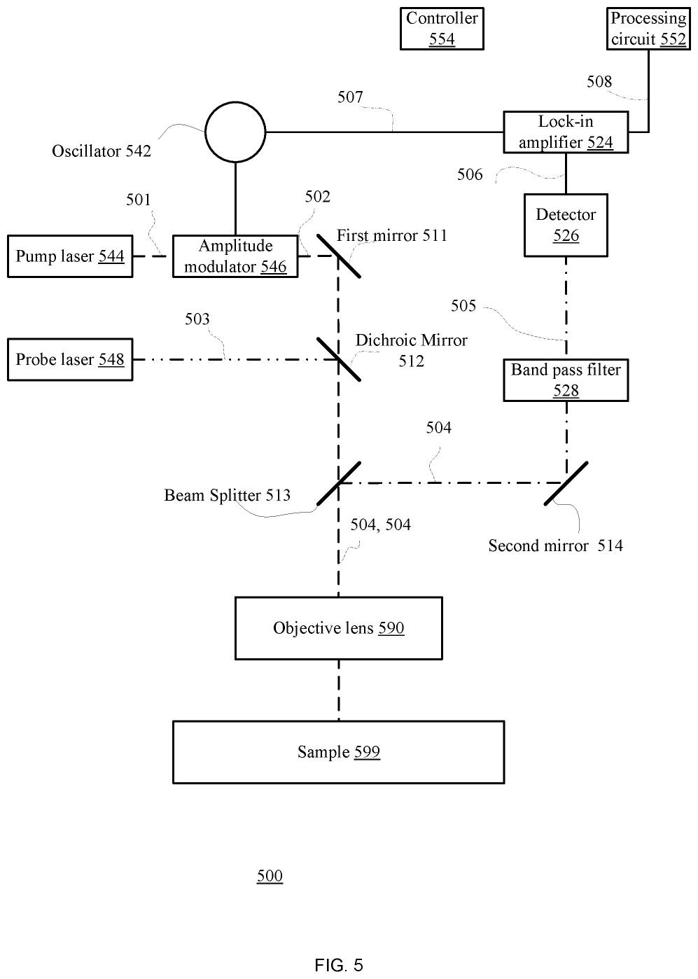

FIG. 5 illustrates an example of an evaluation system 500, that includes probe laser 548 for outputting a probe beam 502, a pump laser 544 for generating the pump beam 501, an amplitude modulator 546 for modulating the pump beam to provide a modulated probe beam 502, a first mirror for reflecting the modulated probe beam 502, a beam splitter 513, an objective lens 590, a second mirror 514, a band pass filter 528, a detector 526, a lock-in amplifier 524, a processing circuit 552 and a controller 554.

Each one of the controller 554 and the processing circuit 540 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The pump and probe beams (501 and 503 respectively) are combined by dichroic mirror 512 and propagate co-linearly illuminating the wafer (sample 599) at normal incidence. They are then separated again by a band pass filter 528 (may be a second dichroic mirror) so that only the reflection from the probe beam (505) reaches the detector 526. The signal 506 from the detector is then mixed with the oscillator signal 507 from the oscillator 542 driving the amplitude modulator 546 to extract (by the lock-in amplifier 524) the lock-in signal 508.

The modulation of the pump laser can be achieved as described with an external modulator (opto-mechanical chopper, Acousto-Optic or Electro-Optic) or by direct modulation of the pump laser drive current.

The pump and probe beams can be brought to a common point on the sample in different ways. One is to use different angles of incidence (e.g. with the pump beam at normal incidence and the probe at an oblique incidence), another is by having the two lasers at orthogonal polarizations and using a polarizing beam splitter/combiner.

Similar techniques can also be used for separating the pump and probe in the return path.

According to various embodiments, the pump and probe reach the sample at the desired lateral positions—either overlapping or at a controlled offset—and that no significant fraction of the pump beam reaches the detector as that can interfere with the delicate measurement of the probe beam. If necessary additional spectral filtering of the pump can be done before the detector.

The output signal of the LIA can be represented as amplitude and phase of the sample's thermal response, or in-phase/quadrature.

### Example—Void in a Cu Via Structure

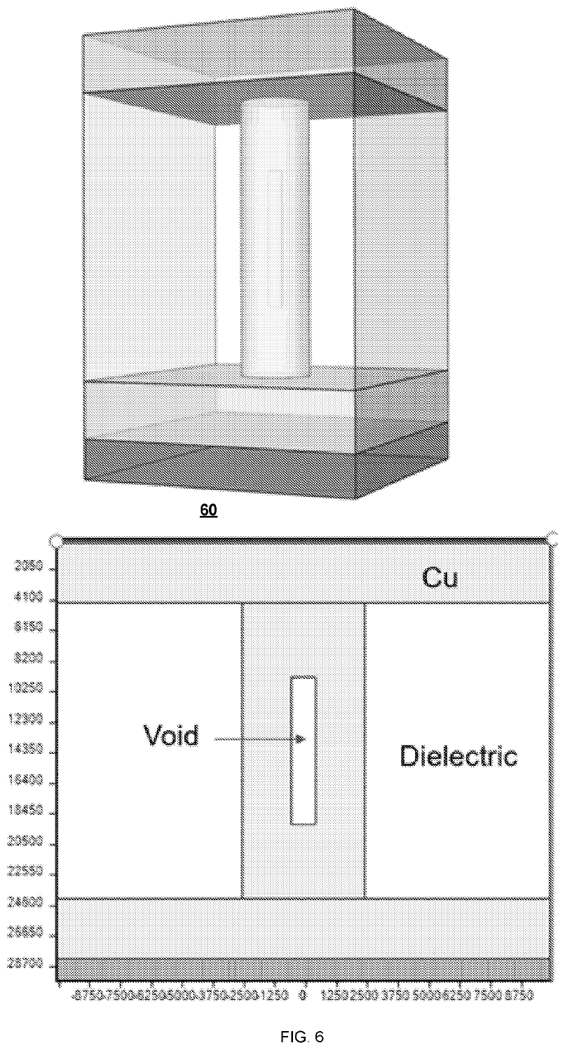

To illustrate how the method works, we present a simulation of the modulated thermal response on a simplified but representative structure. The structure in question (see FIG. 6) is a Cu via connecting two Cu layers and surrounded by a dielectric layer of SiO₂. The top Cu layer is completely opaque to both the pump and probe lasers, so the pump absorption deposits heat in a thin layer near the top surface. The probe measures the thermo-reflectance response which depends approximately linearly on the surface temperature. The bottom surface is in contact with a heat sink at ambient temperature.

After a few cycles of the pump modulation the system settles into a quasi-stationary state where the surface temperature oscillates at f_{mod} with some amplitude and phase.

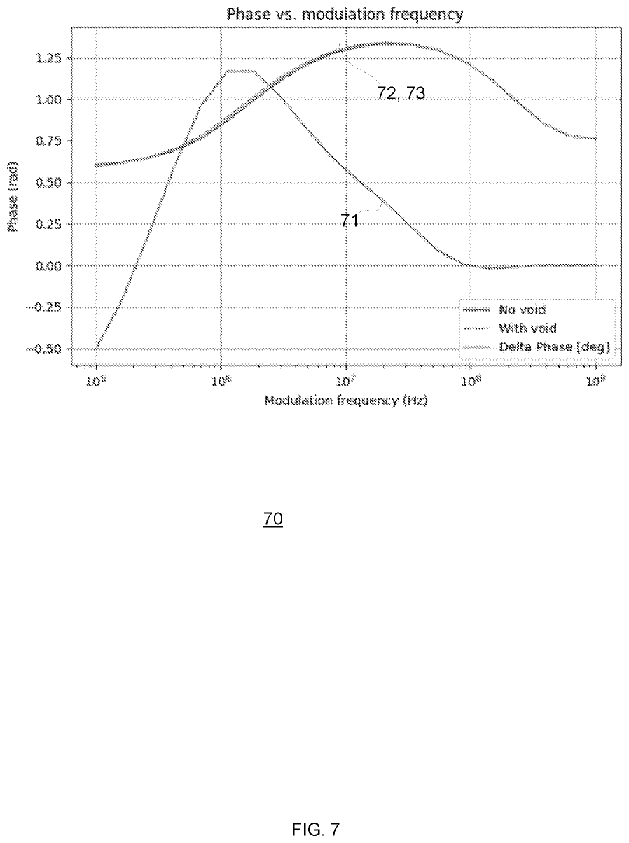

The presence of a void inside the via and its specific dimensions will modify the effective thermal resistance of the via, and thus affect the amplitude and phase of the response in a measurable way. Furthermore, this change will depend on the frequency—at high frequencies Lₘ will be shorter than the top layer thickness, so the oscillatory component of the temperature profile and will be mostly insensitive to the presence or absence of a void. At lower frequencies, the conduction of heat from the top to the bottom layer will be affected by voids, leading to a change in the temperature response on the top surface, and thus to a change of the reflectivity through the thermo-optic effect. This is demonstrated in FIGS. 7,8 showing a simulation results for the structure depicted in FIG. 6.

FIG. 7 includes graph 70 that illustrates the phase versus modulation frequency—as the suggested method measures the phase between the pump laser (which induces heating) and the probe (which measures the surface temperature). This phase is a sensitive probe to how the sample heats up at different modulation frequencies. Curves 72 and 73 present this phase (vs. modulation frequency) for a via with a void (curve 72) and without a void (curve 71). Curve 71 (illustrated at another scale than those of curves 72 and 73) illustrates the difference between curve 72 and 73—it represents the change in the measured phase due to the existence of the void.

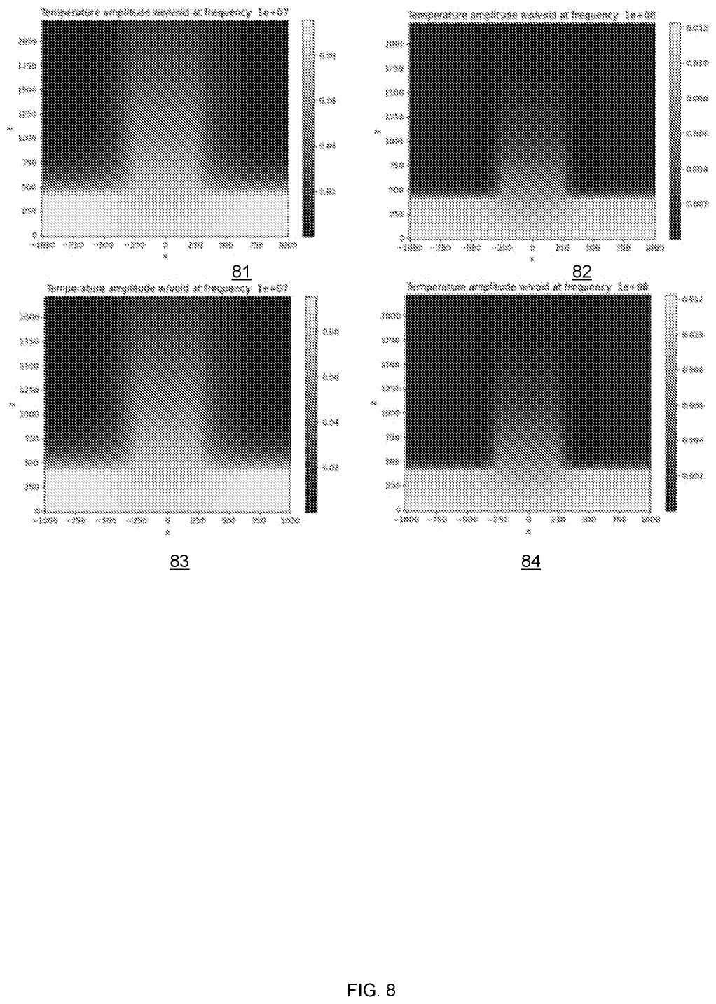

FIG. 8 illustrates (a) a first simulation 81 of temperature amplitude without a void at frequency of 10 MHZ, (b) a second simulation 82 of temperature amplitude without a void at frequency of 100 MHZ, (c) a third simulation 83 of temperature amplitude with a void at frequency of 10 MHZ, and (d) a fourth simulation 84 of temperature amplitude with a void at frequency of 100 MHZ. FIG. 8 includes heat maps of a cross-section through the TSV, with color representing the temperature. The axes are real-space (x axis is lateral dimension, y axis is vertical dimension).

As the signal depends on other parameters such as the via diameter, thermal properties of the material etc., a single measurement does not contain enough information to identify the presence of a void. However this can be overcome by combining measurements at different conditions (modulation frequencies, pump spot size and spatial structure, wavelength etc.) which have different sensitivities to the parameters of the structure.

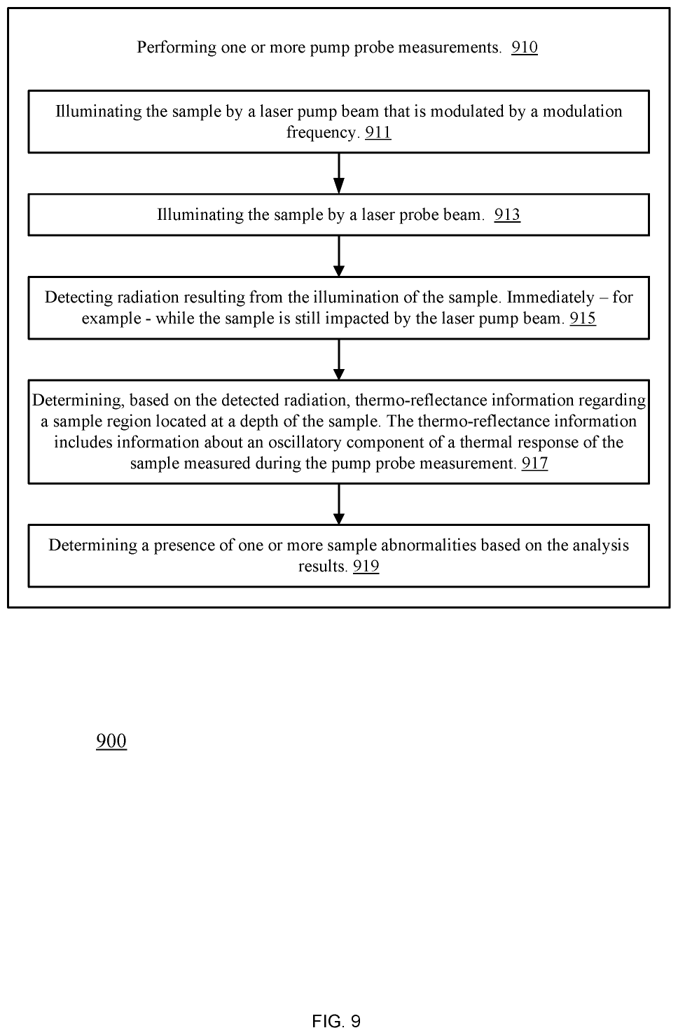

FIG. 9 illustrates an example of a method 900 for evaluating a sample.

Method 900 includes step 910 of performing one or more pump probe measurements.

According to an embodiment, step 910 includes one or more repetitions (one per each pump probe measurement) of steps 911, 913, 915, 917 and 919.

Step 911 includes illuminating the sample by a laser pump beam that is modulated by a modulation frequency.

According to an embodiment, the laser pump beam forms a spot having a spot length that well exceeds a depth to which heat diffuses in a pump probe measurement. The depth depends on the pump modulation frequency. In a transparent or semi-transparent samples (not TSC) the depth of penetration may also depends on the transparency.

According to an embodiment, the spot length associated with the pump probe also well exceeds (for example exceeds by a factor of 2, 3, 4, 5, 6, and more than) a diffusion length of the sample.

Regarding the diffusion length of a sample-material diffusivity is a property of the measured material, and for each material can be either found in literature or experimentally. For a sample that includes one or more patterned structures, the effective diffusivity depends on the different materials of the sample and the structure of the one or more patterned structures. It can be simulated (as previously discussed). It is rather similar to how different materials have different optical properties (n&k) which is enough to understand light propagation in bulk, and when there is a need to understand light propagation in structured materials simulations are used.

Step 911 is immediately followed by step 913 of illuminating the sample by a laser probe beam.

Step 913 is followed by step 915 of detecting radiation resulting from the illumination of the sample. Immediately—for example—while the sample is still impacted by the laser pump beam.

Step 915 is followed by step 917 of determining, based on the detected radiation, thermo-reflectance information regarding a sample region located at a depth of the sample. The thermo-reflectance information includes information about an oscillatory component of a thermal response of the sample measured during the pump probe measurement.

According to an embodiment, thermo-reflectance information regarding sample regions located the different depths of the sample includes a frequency of temperature oscillations of a top of the sample. Step 915 may include detecting the oscillatory component of the thermal responses of the sample using a lock-in amplifier.

Step 917 is followed by step 919 of determining a presence of one or more sample abnormalities based on the analysis results.

According to an embodiment, step 919 includes modeling the a oscillatory component of a thermal response of the sample that is obtained during the given pump probe measurement as a decaying plane wave propagating at a distance that substantially equals the thermal diffusivity of the sample.

According to an embodiment, step 919 includes modeling the sample based on the analysis results.

According to an embodiment, step 910 includes performing a set of pump probe measurements. At least two pump probe measurements of the set differ from each other by modulation frequency of a laser pump beam and provide thermo-reflectance information regarding sample regions located at different depths of the sample. The depth from different depths may provide three dimensional information about the sample.

According to an embodiment, step 910 includes performing yet one or more additional sets of pump probe measurements to provide multiple sets of pump probe measurements.

According to an embodiment, at least two sets of pump probe measurements differ from each other one or more pump probe measurement parameters that differ from the modulation frequency of the laser pump beam.

The pump probe measurement parameters may include a spot size and/or a shape of the spot.

According to an embodiment, there may be one or more repetitions of steps 911, 913 and 915 before performing one or more repetitions of steps 917 and 919.

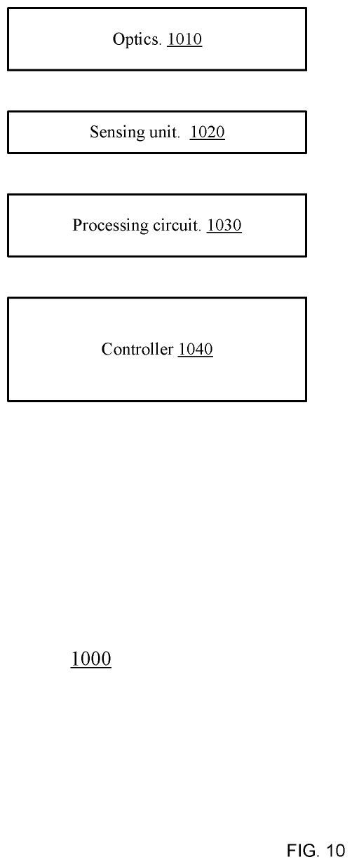

FIG. 10 is an example of an evaluation system 1000.

Evaluation system 1000 includes optics 1010, a sensing unit 1020, a processing circuit 1030 and a controller 1040 that is configured to control a performing of one or more pump probe measurements. An example of an evaluation system is illustrated in FIG. 5. For example—the optical may include pump laser 544, probe laser 548, objective lens 590, band pass filter 528, first and second mirrors 511 and 514, dichroic mirror 512, beam splitter 513, second mirror 514. The sensing unit may include detector 526 and may include lock-in amplifier 514.

During a pump probe measurement:
a. The optics are configured to illuminate the sample by a laser pump beam that is modulated by a modulation frequency; illuminating the sample by a laser probe beam.
b. The sensing unit is configured to detect radiation resulting from the illumination of the sample.
c. The processing circuit is configured to determine, based on the detected radiation, thermo-reflectance information regarding a sample region located at a depth of the sample; thermo-reflectance information comprises information about an oscillatory component of a thermal response of the sample measured during the pump probe measurement; and determine a presence of one or more sample abnormalities based on the analysis results.

According to an embodiment, the laser pump beam forms a spot having a spot length that well exceeds a depth to which heat diffuses in the pump probe measurement.

According to an embodiment, the spot length associated with the pump probe also well exceeds a diffusion length of the sample.

According to an embodiment, the determining of the presence of the one or more sample abnormalities includes modeling an oscillatory component of a thermal response of the sample that is obtained during the pump probe measurement as a decaying plane wave propagating at a distance that substantially equals the thermal diffusivity of the sample.

According to an embodiment, the processing circuit is configured to determine the presence of the one or more sample abnormalities by modeling the sample based on the analysis results.

According to an embodiment, the measurement system is configured to perform of the one or more pump probe measurements by performing a set of pump probe measurements; wherein at least two pump probe measurements of the set differ from each other by modulation frequency of a laser pump beam and provide thermo-reflectance information regarding sample regions located at different depths of the sample.

According to an embodiment, the measurement system is configured to perform of the one or more pump probe measurements by performing one or more additional sets of pump probe measurements to provide multiple sets of pump probe measurements, wherein at least two sets of pump probe measurements differ from each other one or more pump probe measurement parameters that differ from the modulation frequency of the laser pump beam.

According to an embodiment, the pump probe measurement parameters comprise a spot size.

According to an embodiment, the pump probe measurement parameters comprise a shape of the spot.

According to an embodiment, the thermo-reflectance information regarding sample regions located the different depths of the sample are a frequency of temperature oscillations of a top of the sample.

According to an embodiment, the evaluation system includes a lock-in amplifier that is in use for detecting the oscillatory component of the thermal responses of the sample.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. An evaluation system for evaluating a sample, the evaluation system comprises:
optics;
a sensing unit;
a processing circuit;
a controller that is configured to control a performing of one or more pump probe measurements, wherein during a pump probe measurement:
the optics are configured to:
(a) illuminate the sample by a laser pump beam that is modulated by a modulation frequency;
(b) illuminating the sample by a laser probe beam;
the sensing unit is configured to detect radiation resulting from the illumination of the sample;
the processing circuit is configured to:
(a) determine, based on the detected radiation, thermo-reflectance information regarding a sample region located at a depth of the sample; wherein the thermo-reflectance information comprises information about an oscillatory component of a thermal response of the sample measured during the pump probe measurement; and
(b) determine a presence of one or more sample abnormalities based on the analysis results.

2. The evaluation system according to claim 1, wherein the laser pump beam forms a spot having a spot length that well exceeds a depth to which heat diffuses in a pump probe measurement.

3. The evaluation system according to claim 2, wherein the spot length associated with the pump probe also well exceeds a diffusion length of the sample.

4. The evaluation system according to claim 2, wherein the determining of the presence of the one or more sample abnormalities comprising modeling an oscillatory component of a thermal response of the sample that is obtained during the pump probe measurement as a decaying plane wave propagating at a distance that substantially equals the thermal diffusivity of the sample.

5. The evaluation system according to claim 1 wherein the processing circuit it configured to determine the presence of the one or more sample abnormalities by modeling the sample based on the analysis results.

6. The evaluation system according to claim 1 wherein the measurement system is configured to perform of the one or more pump probe measurements by performing a set of pump probe measurements; wherein at least two pump probe measurements of the set differ from each other by modulation frequency of a laser pump beam and provide thermo-reflectance information regarding sample regions located at different depths of the sample.

7. The evaluation system according to claim 6, wherein the measurement system is configured to perform of the one or more pump probe measurements by performing one or more additional sets of pump probe measurements to provide multiple sets of pump probe measurements, wherein at least two sets of pump probe measurements differ from each other one or more pump probe measurement parameters that differ from the modulation frequency of the laser pump beam.

8. The evaluation system according to claim 7, wherein the pump probe measurement parameters comprise a spot size.

9. The evaluation system according to claim 7, wherein the pump probe measurement parameters comprise a shape of the spot.

10. The evaluation system according to claim 1, wherein the thermo-reflectance information regarding sample regions located the different depths of the sample are a frequency of temperature oscillations of a top of the sample.

11. The evaluation system according to claim 1, comprising a lock-in amplifier that is in use for detecting the oscillatory component of the thermal responses of the sample.

12. A non-transitory computer readable medium for evaluating a sample, the non-transitory computer readable medium stores instructions that once executed by a measurement system causes the measurement system to:
perform one or more pump probe measurements, wherein a pump probe measurement comprises:
illuminating the sample by a laser pump beam that is modulated by a modulation frequency;
illuminating the sample by a laser probe beam;
detecting radiation resulting from the illumination of the sample;
determining, based on the detected radiation, thermo-reflectance information regarding a sample region located at a depth of the sample; wherein the thermo-reflectance information comprises information about an oscillatory component of a thermal response of the sample measured during the pump probe measurement; and
determining a presence of one or more sample abnormalities based on the analysis results.

13. The non-transitory computer readable medium according to claim 12, wherein a laser pump beam generated during the pump probe measurement forms a spot having a spot length that well exceeds a depth associated with the pump probe.

14. The non-transitory computer readable medium according to claim 13, wherein the spot length associated with the pump probe also well exceeds a diffusion length of the sample.

15. The non-transitory computer readable medium according to claim 13, wherein the determining of the presence of the one or more sample abnormalities comprises modeling an oscillatory component of a thermal response of the sample that is obtained during the pump probe measurement as a decaying plane wave propagating at a distance that substantially equals the thermal diffusivity of the sample.

16. The non-transitory computer readable medium according to claim 12, wherein the determining of the presence of the one or more sample abnormalities comprises modeling the sample based on the analysis results.

17. The non-transitory computer readable medium according to claim 12, wherein the performing of the one or more pump probe measurements comprises performing a set of pump probe measurements; wherein at least two pump probe measurements of the set differ from each other by modulation frequency of a laser pump beam and provide thermo-reflectance information regarding sample regions located at different depths of the sample.

18. The non-transitory computer readable medium according to claim 17, that stores instructions for performing one or more additional sets of pump probe measurements to provide multiple sets of pump probe measurements, wherein at least two sets of pump probe measurements differ from each other one or more pump probe measurement parameters that differ from the modulation frequency of the laser pump beam.

19. The non-transitory computer readable medium according to claim 18, wherein the pump probe measurement parameters comprise a spot size.

20. The non-transitory computer readable medium according to claim 18, wherein the pump probe measurement parameters comprise a shape of the spot.

21. The non-transitory computer readable medium according to claim 12, wherein the thermo-reflectance information regarding sample regions located the different depths of the sample are a frequency of temperature oscillations of a top of the sample.

22. The non-transitory computer readable medium according to claim 12, that stores instructions for detecting the oscillatory component of the thermal responses of the sample using a lock-in amplifier.

23. A method for evaluating a sample, the method comprises:
performing one or more pump probe measurements, wherein a pump probe measurement comprises:
illuminating the sample by a laser pump beam that is modulated by a modulation frequency;
illuminating the sample by a laser probe beam;
detecting radiation resulting from the illumination of the sample;
determining, based on the detected radiation, thermo-reflectance information regarding a sample region located at a depth of the sample; wherein the thermo-reflectance information comprises information about an oscillatory component of a thermal response of the sample measured during the pump probe measurement; and
determining a presence of one or more sample abnormalities based on the analysis results.

24. The method according to claim 23, wherein a laser pump beam generated during a given pump probe measurement forms a spot having a spot length that well exceeds a depth to which heat diffuses in a pump probe measurement.

25. The method according to claim 24, wherein the spot length associated with the given pump probe also well exceeds a diffusion length of the sample.

26. The method according to claim 24, wherein the determining of the presence of the one or more sample abnormalities comprising modeling the a oscillatory component of a thermal response of the sample that is obtained during the given pump probe measurement as a decaying plane wave propagating at a distance that substantially equals the thermal diffusivity of the sample.

27. The method according to claim 23, wherein the determining of the presence of the one or more sample abnormalities comprising modeling the sample based on the analysis results.

28. The method according to claim 23, wherein the performing of the one or more pump probe measurements comprises performing a set of pump probe measurements; wherein at least two pump probe measurements of the set differ from each other by modulation frequency of a laser pump beam and provide thermo-reflectance information regarding sample regions located at different depths of the sample.

29. The method according to claim 28, comprising performing one or more additional sets of pump probe measurements to provide multiple sets of pump probe measurements, wherein at least two sets of pump probe measurements differ from each other one or more pump probe measurement parameters that differ from the modulation frequency of the laser pump beam.

30. The method according to claim 29, wherein the pump probe measurement parameters comprise a spot size.

31. The method according to claim 29, wherein the pump probe measurement parameters comprise a shape of the spot.

32. The method according to claim 23, wherein the thermo-reflectance information regarding sample regions located the different depths of the sample are a frequency of temperature oscillations of a top of the sample.

33. The method according to claim 23, comprising detecting the oscillatory component of the thermal responses of the sample using a lock-in amplifier.
